(19) United States
(12) Patent Application Publication
(10) Pub. No.: US 2015/0242929 A1
(43) Pub. Date: Aug. 27, 2015

(54) METHOD AND SYSTEM FOR IMPROVING SIZE-BASED PRODUCT RECOMMENDATIONS USING AGGREGATED REVIEW DATA

(71) Applicant: Shoefitr, Inc., Pittsburgh, PA (US)

(72) Inventors: Matthew Tyler Wilkinson, Pittsburgh, PA (US); Nicholas B. End, Pittsburgh, PA (US); Grant B. Fresen, Pittsburgh, PA (US)

(21) Appl. No.: 14/629,757

(22) Filed: Feb. 24, 2015

Related U.S. Application Data
(60) Provisional application No. 61/943,606, filed on Feb. 24, 2014.

(51) Int. Cl. G06Q 30/06

(52) U.S. Cl. CPC G06Q 30/0631

(57) ABSTRACT

A recommendation system collects and aggregates customer feedback information to improve recommendations of wearable items to a consumer as well as provide manufacturers feedback related to their products. For example, the recommendation system may provide a user of a product selection system with an automated recommendation of a recommended size for a selected wearable item. After the user has purchased the selected wearable item, the system may present the user with a prompt to provide feedback relating to the item and/or a quality of the automated recommendation. When the system receives the feedback from the user and other consumers, the system may aggregate the user feedback to improve an aspect of the recommended size of the selected wearable item in the future. Additionally, the user's feedback, or a collection of aggregated user feedback, can be provided to the manufacturer of the purchased item.

### CLAIM OF PRIORITY AND REFERENCE TO RELATED PATENT PUBLICATIONS

This patent document claims priority to U.S. Provisional Patent Application No. 61/943,606, filed Feb. 24, 2014, the disclosure of which is incorporated herein by reference in its entirety.

The disclosure of U.S. Pat. No. 8,521,616, issued Aug. 27, 2013 and entitled “Method and System for Providing Fitting and Sizing Recommendations,” is hereby incorporated by reference in its entirety. Additionally, this application is related to: (i) U.S. Patent Application Publication No. 2014/0032369, filed Jul. 25, 2013, entitled “Method and System for Providing Fitting and Sizing Recommendations”; (ii) U.S. Patent Application Publication No. 2012/0316827, filed Jun. 8, 2012, entitled “Internal Measurement Collection System and Method of Using Same”; and (iii) U.S. patent application Ser. No. 14/561,765, filed Dec. 5, 2014, titled “Method and System for Recommending a Size of a Wearable Item,” the disclosures of which are hereby incorporated by reference in full.

### BACKGROUND

This disclosure relates to methods and systems for recommending sizes of products to consumers, such as apparel, footwear, and other wearable items. More specifically, this disclosure relates to methods and systems that aggregate review data received from multiple consumers to improve the product size recommendations that the system makes to consumers in the future.

When shopping online, it is difficult for consumers to select the correct size of an apparel item because the consumers are unable try on the apparel before it is shipped. A consumer must select a size that he or she thinks will fit and can only try the apparel on after the apparel is delivered. However, sizes may vary among various manufacturers, which may cause a consumer to select an incorrect size. Situations like this lead to a high number of apparel returns, increasing shipping costs for the retailer, the consumer, or both. Many people choose not to purchase apparel online at all due to the risk of not being satisfied with a purchase and having to return the item.

One example of size varying greatly among manufacturers is in footwear. Many consumers choose not to shop for footwear online because they cannot physically try on the footwear and do not want the inconvenience of returning improperly fitting footwear. Furthermore, those who do shop online typically re-purchase a particular model and size of footwear which they are already familiar, thus limiting the consumer's selection potential.

Finding the ideal fit for footwear is also problematic because of the potential for lack in consistency in sizing among footwear manufacturers. For example, a size 10 shoe or boot from one footwear manufacturer may have different dimensions that are different from those of a size 10 shoe or boot from another footwear manufacturer. Internal dimensions may even differ between models offered by a single manufacturer. Manufacturers continually change and discontinue models, so there is typically a need for the consumer to try on new shoes even if the consumer has found a good fit in, and previously purchased, a given shoe model.

These sizing problems are not unique to footwear. Additional types of wearable items also vary in size between manufacturers. Varying sizes can be found in nearly all types of wearable items and apparel, including, but not limited to, outerwear, clothing, underwear, lingerie, hats, gloves, glasses and sunglasses, helmets, and other similar wearable items. For example, a women's size 8 dress as designed and manufactured by company X can have different internal measurements when compared to a women's size 8 dress as designed and manufactured by company Y. Due to such sizing differences, a person who typically wears a size 8 by company X might be more comfortable in a size 10 by company Y. However, typical online retailers do not provide a level of sizing information that enables a consumer to be aware of these differences prior to purchasing.

Additionally, individual items offered for sale by the same manufacturer may vary in standard sizes from other items offered by that same manufacturer. For example, a shoe manufacturer may sell multiple models of running shoes. When comparing each of the running shoe models, for the same size (e.g., size 10 as described above), various internal measurements may vary between the shoe models. For example, a first shoe model may have a narrower toe box than a second shoe model, even when comparing the two shoe models in identical sizes.

Additional characteristics such as overall length, arch support, heel support, width, cushioning, and other fit and comfort characteristics may vary between models produced by the same manufacturer. A consumer may desire a combination of characteristics from multiple items, but collecting and aggregating such information related to consumer feedback is difficult on a large scale, thus it is difficult to provide the manufacturer with meaningful customer feedback.

### SUMMARY

In one embodiment, one or more processors of a system implement programming instructions for a method of generating a user-specific recommended size of a wearable item. The processor(s) access a memory device containing a data set containing parameters for a plurality of wearable items. The processor(s) will identify a wearable item from the data set, query the memory device to retrieve the parameters for the identified wearable item, and analyze the retrieved parameters to determine whether the identified wearable item runs true to size. The system will also save the determination of whether the selected product runs true to size to the data set. One or more of the processors will also receive a selection of the identified wearable item from a first user via a user interface. The processor(s) will query the memory device to receive the determination of whether the selected product runs true to size. If the system determines that the selected product does not run true to size, it will determine an alternate size of the wearable item that is appropriate for the user, generating a recommendation that the user select the alternate size for the product, and cause an output of an electronic device to present the recommendation to the user. The determination of whether or not the selected product runs true to size may be done in response to receiving the user's selection of the product, or previously in an earlier step.

Optionally, the data set may also contain parameter-specific feedback received from one or more consumers for at least some of the wearable items. If so, then when determining whether the identified wearable item runs true to size the system also may analyze the parameter-specific feedback and consider that feedback in the determination.

The system also may present, to each of the one or more consumers, a user interface comprising a visual representation of the wearable item. When a consumer selects a portion of the wearable item via the user interface, the system may present the consumer with a feedback interface by which the consumer may enter performance feedback or fit feedback related to the selected portion of the wearable item, and it may save the received feedback to the data set for the wearable item.

In some embodiments, the process of determining the alternate size may include: (i) accessing the data set to receive a model representation for the selected wearable item, wherein the model representation comprises one or more sizes and, for each size, a plurality of measured parameters of the wearable item in that size; (ii) accessing profile data for the user; and (iii) using the profile data for the user and the model representation for the selected item to determine the alternate size. In another embodiment, the process of determining the alternate size may include: (i) prompting the user to input alternate sizing information, wherein the alternate sizing information comprises an indication of whether the user may purchase a size that is larger or smaller than a primary size for the user; and (ii) using the alternate sizing information to determine the alternate size. In another embodiment, the process of determining the alternate size may include: (i) accessing the data set to receive a model representation for the selected wearable item, wherein the model representation comprises one or more sizes and, for each size, a plurality of measured parameters of the selected wearable item in the user's primary size; (ii) determining whether one or more of the parameters of the selected wearable item differ from one or more reference parameter values by at least a threshold amount; (iii) if the measured parameters of the selected wearable item are greater than one or more of the reference parameters by at least the threshold amount, then selecting the alternate size as a size that is smaller than the primary size; (iv) if the measured parameters of the selected wearable item are less than one or more of the reference parameters by at least a threshold amount, then selecting the alternate size as a size that is larger than the primary size; and (v) if the measured parameters of the selected wearable item are neither less than nor greater than one or more of the reference parameters by at least a threshold amount, then selecting the primary size as the alternate size.

Optionally, after the user has purchased the selected wearable item in the alternate size, the system may present the user with a prompt to provide feedback relating to a quality of the recommendation. When the user does this the system may then receive the feedback from the user in response to the prompt; and it may save the feedback to the memory device containing the data set for the selected wearable item. Optionally, when the system presents the user with the prompt to provide feedback relating to a quality of the automated recommendation, the system may present the user with a graphic virtual model of the selected wearable item, along with a description of the measured characteristic of the wearable item and a visual indication of a location on the wearable item that is associated with the measured characteristic. Then, when receiving the feedback from the user, the system may receive an indication of whether the user considers the description of the measured characteristic to be accurate.

Optionally, when the system presents the user with the recommendation of the recommended size, the system may: (i) receive, via a user interface that presents a visual indication of the selected item, a user selection of a location on the selected item; and (ii) in response to receiving the indication of the user selection of the location, cause the user interface to display a measured parameter of the selected wearable item that is associated with the selected location.

Optionally, the system may also receive feedback from additional consumers in response to additional recommendations for the selected item in the selected size that were presented to the additional consumers. If so, then the system may analyze the feedback to identify a trend in a physical characteristic of the selected wearable item for which the additional users substantially consistently express negative feedback, and it may send a supplier of the selected wearable item a message comprising a summary of the negative feedback and the characteristic of the selected wearable item for which the additional users substantially consistently express negative feedback.

Optionally, the system may include a scanning device that is configured to be inserted into the identified wearable item. When the device is inserted into the item, the device may collect internal dimensional and tactile measurements of various parameters of the identified wearable item. The collected measurements will be transmitted to the memory device and saved in the data set as values of parameters for the identified wearable item, to be used when recommending an alternate size.

### BRIEF DESCRIPTION OF THE DRAWINGS

FIG. 1 illustrates an example of a computer network according to an embodiment.

FIG. 2 illustrates a process for prompting a user to provide sizing information and providing a size recommendation according to an embodiment.

FIG. 3 illustrates a process for determining whether a selected item runs true to size and providing a size recommendation to a user according to an embodiment.

FIG. 4 illustrates a process for providing a size recommendation to a user based upon determined personal dimensions for the user according to an embodiment.

FIG. 5 illustrates a process for providing a recommended size to a user for a wearable item that does not run true to size according to an embodiment.

FIG. 6A illustrates a sample element of a user interface for receiving primary sizing information according to an embodiment.

FIG. 6B illustrates a sample element of a user interface for receiving secondary sizing information according to an embodiment.

FIG. 7 illustrates a sample user interface element showing a size recommendation according to an embodiment.

FIG. 8 illustrates a sample user interface element that informs a user that a selected item does not run true to size according to an embodiment.

FIG. 9 illustrates a sample user interface element for providing feedback related to an item previously recommended to the user according to an embodiment.

FIG. 10 illustrates a sample user interface element for viewing aggregated user feedback and review information related to previously recommended products according to an embodiment.

FIG. 11 illustrates a process for collecting, aggregating and utilizing user feedback related to previously recommended items according to an embodiment.

FIG. 12 illustrates various embodiments of a computing device for implementing various methods and processes described herein.

FIGS. 13A and 13B illustrate an example of an apparel item parameter measuring device.

FIG. 14 illustrates additional features of the measuring device of FIGS. 13A and 13B.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

As used herein, “wearable item” or “apparel” refers to any item or collection of items that are designed, sized and/or configured to be worn by a person. Examples of wearable items or apparel include footwear, outerwear (including, but not limited to coats, jackets, ponchos, capes, robes, cloaks, gloves, and other related outerwear), clothing (including, but not limited to, socks, pants, shorts, skirts, dresses, shirts, gowns, sweaters, hosiery, suits, underwear, lingerie, saris, wraps, swimsuits, neckwear, belts, and other related clothing), headgear (including, but not limited to, hats, helmets, glasses, sunglasses, goggles, earmuffs, scarves, and other related headgear), sporting accessories (including, but not limited to, pads, shin-guards, mouthpieces, protective sleeves, sports-specific gloves, and other related sporting accessories) and other related wearable items.

“Footwear” refers to any type of apparel that may be worn on a person's lower body, specifically the feet and optionally also the lower legs. Examples include athletic shoes and other shoes, work boots, ski boots and other boots, sandals, slippers, and any other apparel item designed to be worn on the foot and optionally also the lower leg.

“Apparel model” or “wearable item model” refers to a specific type or version of apparel offered by a manufacturer, typically having a name, model and item number or code. For example, a footwear model refers to a specific model of footwear offered by a manufacturer.

“Apparel representation” refers to a computer-readable representation of an apparel model stored in a computer readable medium. An apparel representation may be a two dimensional or a three dimensional representation. For example, a footwear representation may be a 3D representation of a specific footwear model.

A “computing device” or “electronic device” refers to a device that includes a processor and non-transitory, computer-readable memory. The memory may contain programming instructions that, when executed by the processor, cause the computing device or electronic device to perform one or more operations according to the programming instructions. As used in this description, a “computing device” or an “electronic device” may be a single device, or any number of devices having one or more processors that communicate with each other and share data and/or instructions. Examples of computing devices and/or electronic devices include personal computers, servers, mainframes, gaming systems, televisions, and portable electronic devices such as smartphones, personal digital assistants, cameras, tablet computers, laptop computers, media players and the like. Unless the context specifically dictates otherwise, the term “processor” will include embodiments having a single hardware processor, as well as embodiments in which multiple hardware processors collectively perform various steps of a process. Similarly, the term “memory” and “computer-readable medium” may include a single memory device, a particular sector or portion of a single memory device, or a collection of multiple memory devices.

As discussed above, various problems exist in attempting to match a user to a specific model of apparel based upon user measurements and manufacturers' data. The present disclosure relates to various methods and systems for determining and providing sizing information to a user for a specific apparel item in response to a user selection of the apparel item from a retailer, for example, an online retailer.

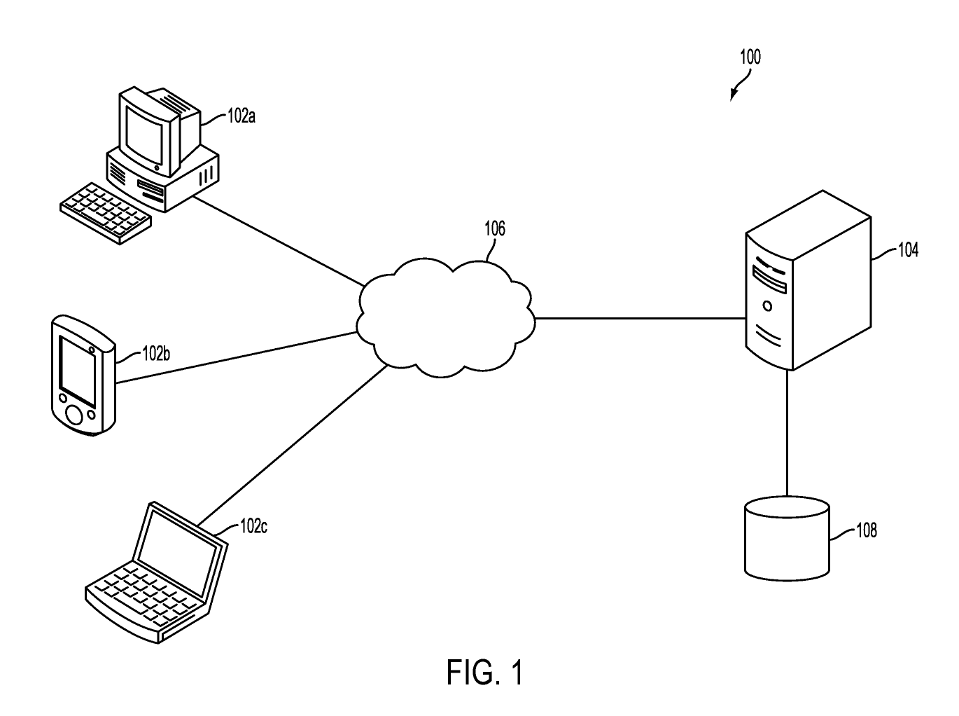

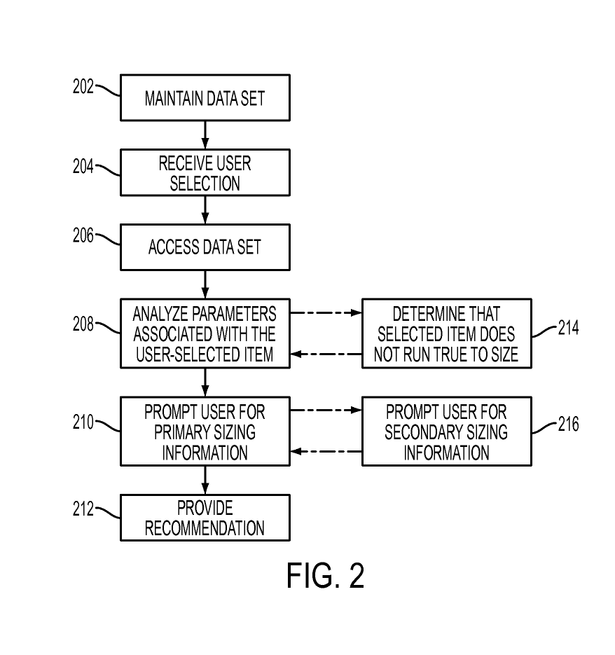

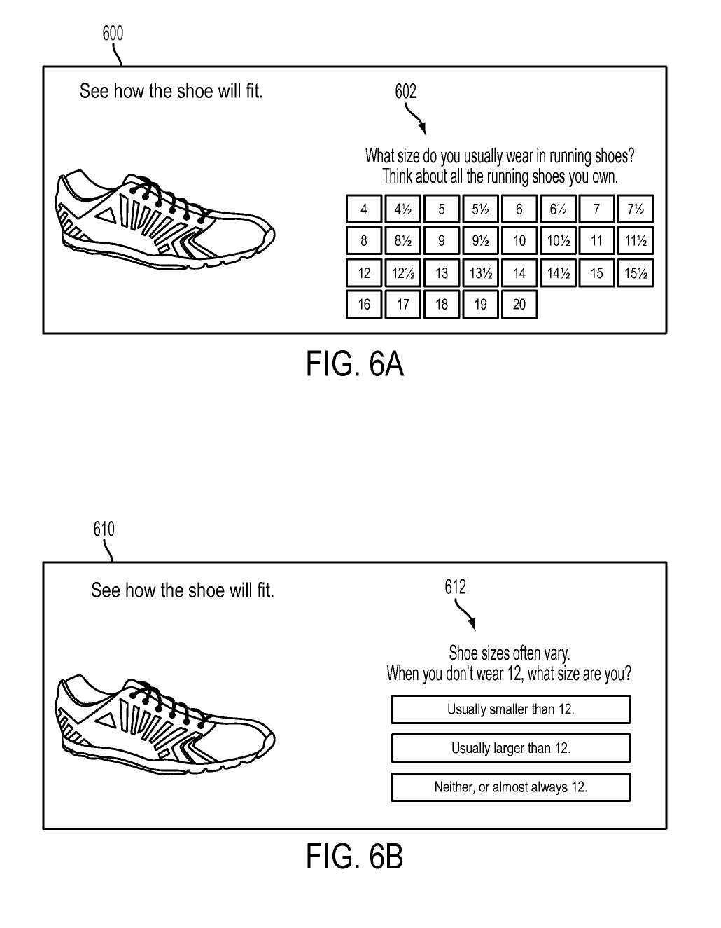

FIG. 1 illustrates an example of a communications network 100 according to an embodiment. The network 100 may include various user computing devices such as desktop computer 102a, portable device 102b (including, but not limited to smart phones, personal digital assistants, tablet computing devices, or other portable devices capable of establishing a communications link), and laptop or notebook computer 102c. The computing devices 102a, 102b, 102c may be accessed by the user in various locations such as at home, at a store, at work, at an airport, or any other similar location. A user may access a browser or similar user interface at one of the computing devices 102a, 102b, 102c to connect to a server 104 via a communications network 106. The server 104 may include a computer readable memory device containing instructions for performing a process of determining and recommending sizing information to the user in response to various user actions such as selecting an apparel item for sale and/or selecting an available size for an apparel item for sale. Examples of steps of this process are discussed in more detail in the description of FIGS. 2-5 below. Descriptions of the accompanying user interface elements as illustrated in FIGS. 6-8 are described throughout the discussion of FIGS. 2-5 as appropriate.

It should be noted that the following discussions are directed to footwear by way of example only. The ideas, processes and techniques as described herein are not intended to be limited to footwear, and are applicable to any apparel item having one or more measurements and dimensions related to the fit of the apparel item on a person wearing the apparel item.

FIG. 2 illustrates a sample process for providing a sizing recommendation for wearable items such as footwear. A memory device in a computing device, such as server 104 as described above, or in one of computing devices 102a, 102b or 102c, or in a separate data storage facility, can maintain 202 a stored data set including identifying information for a plurality of wearable items and data related to each wearable item. The data can include a set of internal measurements and other fit and performance parameters that may be obtained for each wearable item and imported into the data set such that a two dimensional (2D) or three dimensional (3D) representation of the wearable item may be constructed. The data set also may include feedback about the wearable items as reviewed by multiple consumers, as will be described in more detail below.

For example, for a footwear model, the internal measurements can include a total length measurement, a total width measurement, heel width, arch length and arch width. When applicable, additional parameter measurements can also be stored, including, but not limited to, toe box height, forefoot height, and arch height. Three dimensional measurements may be stored within the data set as well, such as toe box girth, forefoot girth, and heel to toe girth. Measurement parameters such as tapering or change in width as a percentage of total length can also be stored within the data set. It should be noted that this list of measured parameters is provided by way of example only, and additional parameters measurements may be included such as heel height, arch height, girth, foot opening diameter, and any other relevant information.

In additional to dimensional measurements described above, other parameter measurements may be associated with a footwear model depending on model type. For example, a running shoe may have feature-based parameter measurements associated with stability whether or not the shoe has motion control, racing spikes, and any other relevant parameters. Tactile measurements such as cushioning, stretch and deformation also may be available for various areas in the footwear model. The system may receive these parameter measurements from one or more scanning devices that scan the footwear model and collect measurement data from the footwear model. An example of such a device will be described in more detail below and is disclosed in U.S. Patent Application Publication No. 2012/0316827, the disclosure of which is incorporated herein by reference in its entirety. Additionally or instead, the system may receive measurement data for at least some footwear models via user input, via a communication from manufacturer of the footwear, or both. Depending on the information available, some additional measured parameters may be assigned a numerical or descriptive value representing the measurement. For example, one particular model of running shoe may have approximately 1 cm of stretch in the heel area. Another model may have a high level of cushioning. In the data set, for this shoe model the measurement parameter for cushioning may be set to “high” or a similar numerical value representing a high level of cushioning. Alternatively, some additional measurement parameters may be assigned merely a binary value representing a true/false or yes/no value, indicating whether or not the footwear model exhibits this additional parameter. For example, a running shoe having racing spikes may only have an associated value of “yes” (or “true” or “1”) as the value for a “racing spikes” parameter in the data store.

In addition, the parameters may include additional retail-specific parameters. For example, information related to consumer ratings can be stored in the data set. Similarly, information such as return or replacement numbers and reasons for return can be stored in the data set to provide additional information related to a particular wearable item.

By implementing programming instructions, the computing device may receive 204 a user selection of an item to purchase via a user interface such as a touch screen, keyboard or keypad, voice input, or other user interface. The computing device may be part of a system that may provide a website or similar user interface that the user may access via a remote computing device, and the user may utilize the user interface to select the item to purchase, as well as to view and/or select additional information related to the item such as color and style. Various input features may be provided in the user interface such as text fields, drop down menus, or other input devices to aid in the user during selection. The user may select a size of the item, or the computing device may select an initially recommended size using systems such as those described in related U.S. Pat. No. 8,521,616.

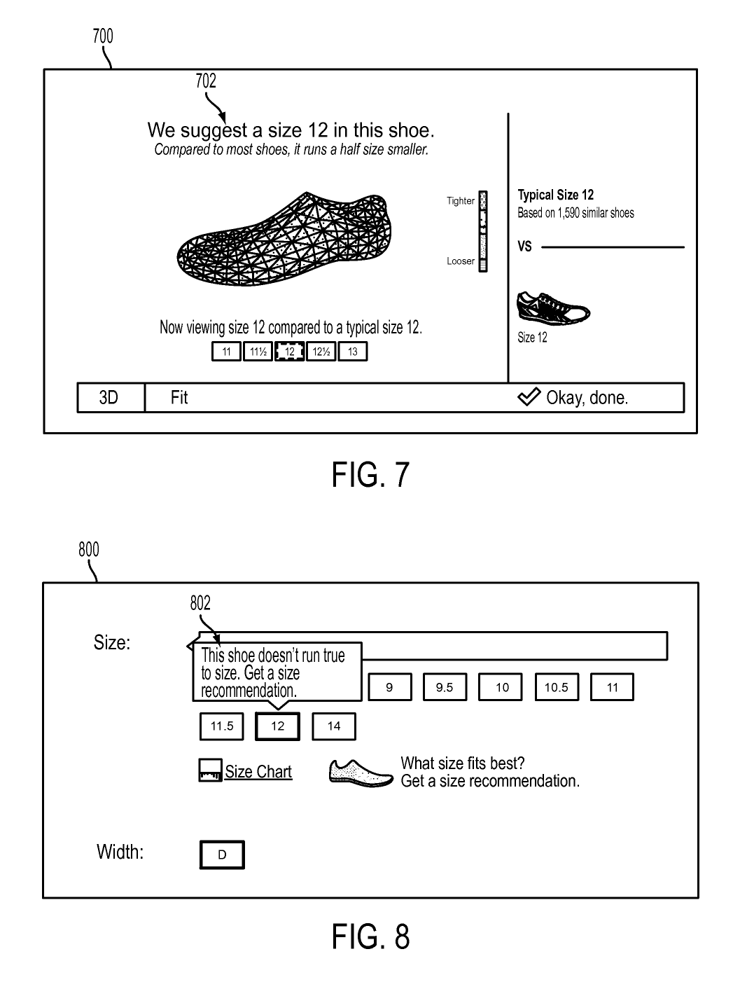

The computing device can access 206 the data set to retrieve the stored information related to the user-selected item, and analyze 208 the stored measurements and parameters associated with the user-selected item. The computing device may also prompt 210 the user to provide sizing information. For example, as shown in FIG. 6A, a screenshot of a user interface element 600 shows a sample user interface 602 for prompting 210 the user to provide primary sizing information. Specifically, as shown in FIG. 6A, the system prompts the user to provide the size that he or she typically wears in a running shoe. Alternatively, the system may retrieve the user's primary size from information previously provided by the user, such as a user profile or previous purchase data. After the system receives the user's primary sizing information, the system may determine a recommended size of the user-selected item and provide 212 the recommendation. The determined size may be a primary size or an alternate size, depending on the model selected and whether or not the selected size of that model runs true to fit. The size determination process will be described in more detail below. FIG. 7 illustrates a sample screenshot of a user interface element 700 including a recommendation 702 to the user of a specific size of footwear to purchase.

Optionally, the process as shown in FIG. 2 may include various other programming features and process steps. For example, as part of or to assist with the size recommendation process, during analysis 208 the computing device may also determine 214 whether the user-selected item runs true to size. The system may make this determination before or after the user selects a product by comparing the stored parameter measurements for the user-selected item to standard information related to standard sizes. If one or more of the measured parameters differs by more than a threshold amount from the value(s) of its or their corresponding reference (standard) parameters, then the system may determine that the model of item does not run true to size. For example, for footwear, the system may compare internal measurements such as length and width for the user-selected item (e.g., a size 12 running shoe) to standard internal measurements for an industry standard (i.e., a reference model) running shoe. To determine the industry standard for a given parameter (i.e., maximum length or width of the overall shoe interior, or of a portion such as the toe box or heel), the computing device may compute an overall average for the parameter for all models that are stored in the data set in that particular size (e.g., overall averages of all internal measurements of all size 12 shoes). Alternatively, the industry standard size may be stored in the data set as provided by a manufacturer, a group of manufacturers, a suppler or group of suppliers, a retailer or a group or retailers, or other similar groups. The system also may consider tactile measurements such as stretch or deformation and use the size corresponding to maximum, minimum, or some intermediate level of stretch or deformation as the shoe's internal measurement in the comparison.

During determination of whether an item runs true to size 214, the system may also consider data that reflects how an item fits as opposed to, or in addition to, determining whether the item is true to standard size. For example, a high heel shoe may include one or more straps that cross the top or arch of a wearer's foot and attach at various points on the sides of the shoe. When worn, one or more of the straps can cause the shoe to fit differently on the wearer's foot, thereby altering the fit and comfort of the shoe. Thus, the data set for that footwear model may include positive value (e.g., “yes,” “true,” or “1” for a parameter titled “horizontal straps”). The system may also consider such a feature, including various structural and decorative features integrated onto an item, that results in possible deviation from a user's selected size of that item when determining 214 whether the user-selected item runs true to size.

Additionally, in the process as shown in FIG. 2, any computing device in the system can also execute programming instructions that cause it or another computing device to prompt 216 the user for secondary sizing information and receive the secondary sizing information from the user via a user interface. Secondary sizing information may the size that the user is most likely to wear if their primary size does not fit properly, or an indication of whether the user is most likely to pick a larger or smaller size if their primary size does not fit properly. FIG. 6B provides a sample screenshot of a user interface element 610 illustrating a user interface 612 for prompting 216 the user for secondary sizing information. As shown in FIG. 6B, the secondary sizing information may be related to an alternative size the user wears when they do not wear their primary size. The computing device may use the secondary sizing information to provide 212 a more accurate size recommendation for the user.

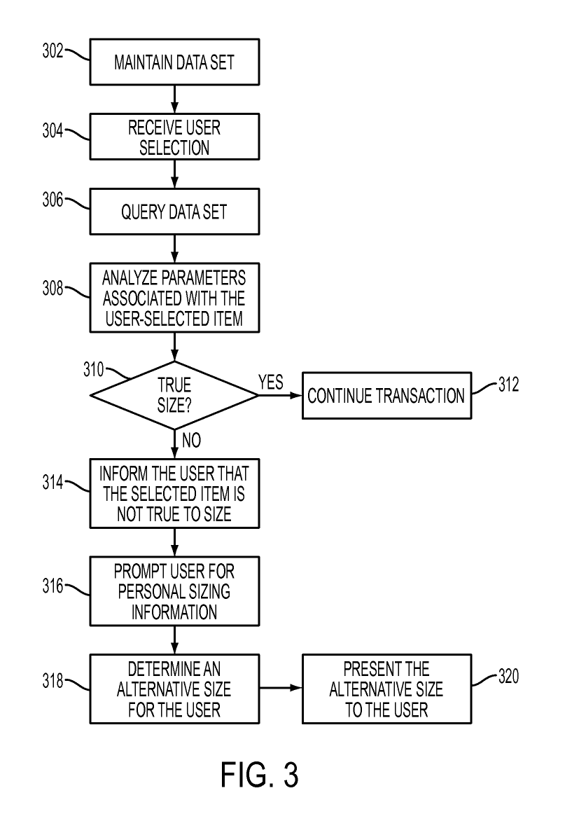

FIG. 3 illustrates a sample process for providing a sizing recommendation for a wearable item such as footwear based upon whether the wearable item runs true to size. A computing device, such as server 104 as described above, maintains 302 and/or accesses a data set including identifying information a plurality of models of wearable items and data related to each wearable item model. As noted above in the discussion of FIG. 2, the data set can include various measurements and parameters related to each of the wearable item models.

The computing device may receive 304 a user selection of an item to purchase, along with an initial size for the item. The initial size may be received from the user via a user interface. Alternatively, the system may access a stored user profile for the user and retrieve the initial size from the user profile, either from previous purchase data or from a reference size parameter stored in the user profile. The computing device can query 306 a relevant memory sector of the data set for the wearable items to retrieve the stored measurements and parameters related to the user-selected item, and it can then analyze 308 the stored measurements and parameters associated with the user-selected item. In particular, the computing device can analyze 308 the parameters and determine 310 whether the user-selected item runs true to size. As noted above, a determination may be made based upon the stored measurements and parameters for the user-selected item as compared to standard information related to standard sizes.

If the computing device does determine 310 the user-selected item runs true to size, the computing device can continue 312 the transaction using the user-selected or user profile-based initial size for the item. For example, if the computing device determines 310 that a size 12 in the user-selected shoe runs true to the industry standard size 12, the computing device may continue 312 the transaction so that the user may purchase the size 12 shoe, without recommending an alternate size.

Conversely, if the computing device determines 310 that the user-selected item does not run true in size, the computing device may inform 314 the user that the item does not run true to size. For example, a user interface being utilized by the user to select the item may be updated to inform 314 the user that the item does not run true to size. FIG. 8 shows a sample screenshot of a user interface element 800, which includes a notice 802 that the user selected item does not run true to size and recommends that the user get and/or consider a size recommendation from the system.

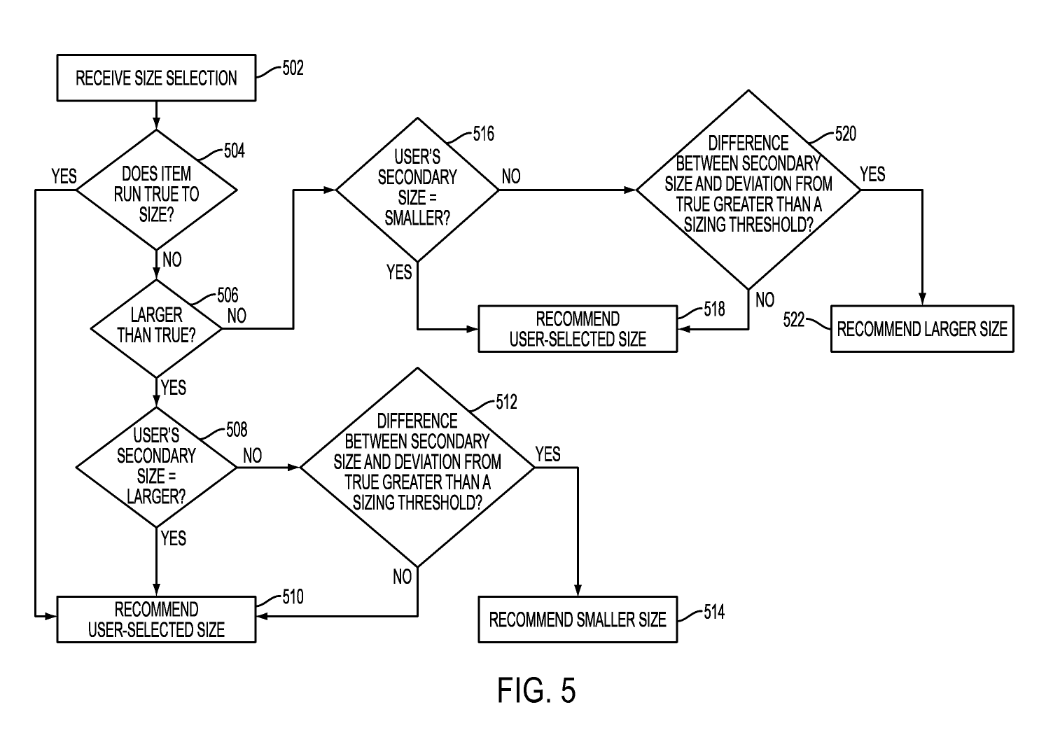

The computing device may prompt 316 the user to provide personal sizing information. For example, as discussed above, the user may be prompted for primary sizing information (if not already provided) and secondary sizing information. In that example, the primary size would be a 12. The secondary sizing information would be that the user, when not wearing a 12, typically wears a size that is smaller than a 12. Based upon the personal sizing information, the computing device may determine 318 an alternative size for the user, and it may present 320 the alternative size recommendation to the user as, for example, a screenshot element such as that shown in FIG. 8. Additional information related to the determination of an alternate size is provided in the discussion of FIG. 5 below.

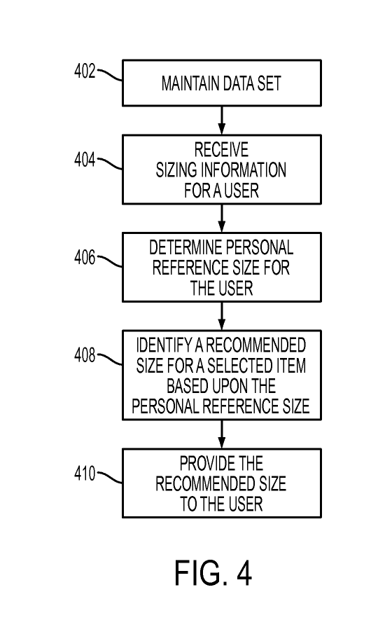

FIG. 4 illustrates a sample process for providing a sizing recommendation for wearable items such as footwear based upon personalized sizing information received from a user. The process as described in FIG. 4 may be applied to additional processes such as those shown in FIGS. 2 and 3 to improve recommendations.

A computing device, such as server 104 or a local computing device such as 102a, 102b or 102c as described above, maintains 402 a data set including a plurality of wearable items and data related to each wearable item. As noted above in the discussion of FIG. 2, the data set can include various measurements and parameters related to each of the wearable items.

The computing device may receive 404 sizing information related to a specific user. For example, the sizing information may include a primary footwear size and a secondary footwear size as has been previously discussed. Based upon the received 404 sizing information, the computing device may determine a personal reference size 406 specific to that user. For example, the user may be prompted to input their primary footwear size, as well as their secondary footwear sizing information. The user may input that their primary footwear size is a 12, and that their secondary footwear sizing information is that they typically wear a size smaller than a 12 when not wearing their primary size. Based upon this information, the computing device may calculate the personal reference size to be an adjusted size that is smaller than size 12. The adjusted size may be a reference fraction between the user's primary size and secondary size, such as halfway between or 1/5 of a size between. For example, for the particular user discussed above, the personal reference size may be similar to a size 11.8, or slightly smaller than the user's primary size. Conversely, if the user indicated that they typically wear larger than a 12 for their secondary sizing information, the computing device may determine 406 that the user's personal reference size is similar to a size 12, or slightly larger than their primary size. The personal reference size need not be determined by measuring the user's actual foot (or other body part), but rather may be based on internal dimensions of hypothetical (modeled) or actual reference footwear items based on data previously provided by the user, or the user's previous purchases.

The computing device can determine the personal reference size by establishing a set of internal wearable item measurements for a reference footwear model and establishing the reference size to be an extrapolated (or interpolated) size that corresponds to the reference model. To continue the above example, the computing device may determine 406 that a user has a personal reference size of about 11.8. The computing device may establish a graph or other similar representation of all footwear that have sizing information stored in the data set, plotting each size against each internal measurement for each individual piece of footwear. The computing device may then fit a best fit line into the data, providing a reference for each measurement as it compares to each footwear size. The computing device can then locate the user's personal reference size, e.g., 11.8, on the graph for each measurement to determine a set of personalized internal measurements for that user.

Based upon the user's personal reference, the computing device may identify 408 a recommended size for a user-selected item, and it may provide 410 the recommended size to the user based on how close the user's reference size runs to an actual size, with an adjustment of the model does not run true to size. To continue the above example, if the computing device determines 406 that a user's personal reference are similar to a size 11.8 and the shoe runs true to size, the computing device may identify 408 a size 12 for the shoe since that shoe size the available size that is closest to the user's reference size. Alternatively, for a shoe that runs larger than true to size, the computing device may identify 408 the first available size that is smaller than the user's reference size. In this case, the identified size would be 11.5.

Optionally, the system may also consider stretch or deformation, and add or subtract an expected stretch or deformation amount from the user-selected item measurements when selecting the size of that time that is appropriate for the user.

FIG. 5 illustrates a sample process for determining and recommending a size for a user when a wearable item does not run true to size. A sizing determination and recommendation process such as that shown in FIG. 5 can be used in conjunction with the processes as described in FIGS. 3 and 4.

A computing device of the size recommendation system may receive 502 a size selection and determine 504 whether the user-selected item runs true to size. If the computing device does determine 504 that the user-selected item runs true to size, the recommendation system may recommend 510 the user-selected size for the selected item.

Conversely, if the computing device determines 504 that the user-selected item does not run true to size, the computing device may determine 506 whether the user-selected item runs larger than true. To make this determination, the computing device may compare one or more internal measurements and/or parameters related to the user-selected item against one or more internal measurements and/or parameters for a standard sized item.

If the computing device determines 506 that the user-selected item runs larger than true, the computing device may determine 508 whether the user's secondary size is larger than their primary sizing information. If the user's secondary sizing information is larger than their primary sizing information, the recommendation system may recommend 510 the user selected size to the user without change. In this example, since the user-selected item tends to run larger than true and the user provided that their secondary sizing information is typically larger than their primary sizing information, the recommendation system may determine that the initial user-selected size is most likely the best fit.

Alternatively, if the user's secondary size is not larger than their primary sizing information, the computing device may determine 512 whether a difference between the user's secondary sizing information and the deviation from true for the user-selected item is greater than a specific sizing threshold. The sizing threshold may be selected as a standard measurement for all items. For example, the threshold may be set at 0.25 inches and associated with a particular parameter such as overall length. Alternatively, the sizing threshold may be selected as a portion of the total length of the selected item. For example, for a footwear item, the threshold may be set as 2.5% of the total length of the selected item. Other parameters and thresholds may be used.

If the computing device determines 512 that the difference is greater than the sizing threshold, the recommendation system may recommend 514 a smaller size to the user. Conversely, if the computing device determines 512 that the difference is less than the sizing threshold, the recommendation system may recommend 510 the user-selected size.

If the computing device determines 506 that the user-selected item runs smaller than true, the computing device may determine 516 whether the user's secondary size is smaller than their primary sizing information. If the user's secondary sizing information is smaller than their primary sizing information, the recommendation system may recommend 518 the user selected size to the user. In this example, as the user-selected item tends to run smaller than true and the user provided that their secondary sizing information is typically smaller than their primary sizing information, the recommendation system may determine that the initial user-selected size is likely to be the best fit.

Alternatively, if the user's secondary size is not smaller than their primary sizing information, the computing device may determine 520 whether a difference between the user's secondary sizing information and the deviation from true for the user-selected item is greater than a specific sizing threshold. If the computing device determines 520 that the difference is greater than the sizing threshold, the recommendation system may recommend 522 a larger size to the user. Conversely, if the computing device determines 522 that the difference is less than the sizing threshold, the recommendation system may recommend 518 the user-selected size.

As noted above, the processes and related examples as discussed with respect to FIGS. 2-5 and the screenshots and user interfaces illustrated in FIGS. 6-8 are directed to footwear by way of example only. The processes and techniques as described in the present disclosure can be applied to all wearable items, beyond those specific examples included herein.

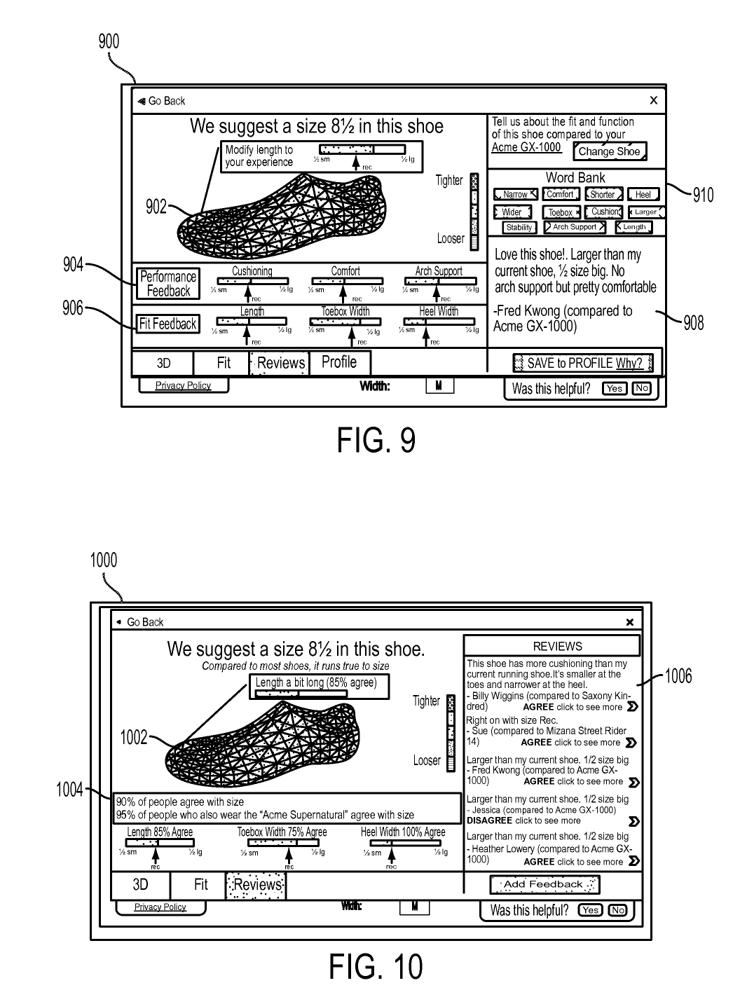

In an additional feature, the system may solicit and collect feedback from multiple users of the recommendation system. The system can store this feedback, aggregate and analyze this feedback, and use it to improve the item recommendation system. Additionally, the system can analyze the feedback to identify any particular trends related to a specific manufacturer or item. In this case, the system may send information related to the feedback to the manufacturer for review. This provides a means for large-scale collection and transmission of item specific review information to a manufacturer. Based upon the feedback information, the manufacturer may decide to alter an item they are currently producing, or produce a new item based upon the feedback. The feedback aggregation and analysis, and subsequent use of the feedback information, is described in greater detail in the following discussion of FIGS. 9-11.

FIG. 9 provides a sample screenshot of a user interface element illustrating a feedback interface 900. As shown in FIG. 9, the feedback interface 900 may include a graphic virtual model rendered as a visual representation 902 of a footwear (or other) item previously recommended to and potentially purchased by the user. The user may be able to select a parameter depicted on the visual representation and provide feedback directly related to that portion of the item. The parameters may be performance-based parameters (such as cushioning, comfort and arch support), fit-based parameters (such as overall length, toebox width, or heel width), or both. For example, as shown in FIG. 9, the user can select the length parameter on the visual representation 902 and provide feedback related to the length of the item. The feedback mechanism may include, for example, a slider as shown in FIG. 9. The slider may include an indication of what the recommendation indicated the length of the item was, as well as a mechanism by which the user may enter feedback information. For example, the user may operate the user interface to move the slider to a position that he or she considers to accurately reflect the length of the item. The user may provide feedback indicating that they agree with the sizing information of the recommendation system or, alternatively, the user can provide personalized feedback information that indicates a potential discrepancy between a recommendation made by the recommendation system and a related characteristic of the actual product.

It should be noted that length is provided by way of example only, and additional portions of the visual representation 902 may be configured to be selectable by the user. Depending upon the item being displayed, various measured characteristics may be displayed, including, but not limited to: a height or width description related to at least a portion of the wearable item; a radius or curvature description related to at least a portion of the wearable item; an angular description related to at least a portion of the wearable item; and a material description or physical property related to at least a portion of the wearable item.

Alternatively, the visual representation 902 may include a visual indication at various locations on the apparel model that the user can select to provide additional feedback. For example, the system may display an array of pixels associated with a particular area of the product as shaded or otherwise altered to provide an indication of a user-selectable area of the visual representation 902. Upon selection of the visual indication, the system may display information related to a measured characteristic (e.g., length as shown above) or performance parameter (such as cushioning) to the user. Thus, the user can select a portion of the visual representation 902 related to an aspect or area of the product for which they would like to leave feedback, whether it is negative feedback about an area of the shoe they would like to see altered (or an area for which the user disagrees with the recommended sizing information), or positive feedback about an area of the shoe (or an area for which the user agrees with the recommended sizing information).

Additionally, the feedback interface 900 may include one or more inputs via which consumers may provide parameter-specific feedback related to one or more specific aspects of the wearable item. For example, as shown in FIG. 9, the feedback interface 900 may include performance feedback inputs 904 by which the user may describe, rate or quantify various performance parameters of the item, as well as fit feedback inputs 906 by which the user may describe, rate or quantify various parameters related to fit of the item. The performance feedback inputs 904 may include, for example, individual feedback inputs related to cushioning, comfort and arch support. However, it should be noted this collection of performance feedback inputs 904 is shown by way of example only. The performance feedback inputs 904 may include the recommendation system's default value for that particular aspect of the item. The inputs also may provide the user with the ability to provide their own feedback should they disagree with the recommendation system's value.

Similarly, the fit feedback inputs 906 may include, for example, individual feedback inputs related to length, toebox width and heel width. However, it should be noted this collection of fit feedback inputs 906 is shown by way of example only. The fit feedback inputs 906 may present the recommendation system's default value for that particular aspect of the item, and they also may provide the user with the ability to provide their own feedback should they disagree with the recommendation system's value. With both performance and fit feedback, the default value may be a standard value or a value that the system determines to be an average or mean of all values received from consumers in feedback for the relevant aspect of the wearable item.

The system may collect additional feedback related to alternate characteristics of an item being reviewed. For example, the system may receive feedback related to aesthetic characteristics from a user. More specifically, the system can collect feedback related to various aesthetic characteristics such as exterior shape, item appearance, exterior material durability, exterior material colors and textures, construction quality, and/or other similar aesthetic characteristics.

The feedback interface 900 may also include a text box 908 where the user can provide a written description of the item. The text box 908 may include a group of related words 910 selected from a bank of related for use by the user in describing the item. The system may determine the set of displayed related words 910 based upon what type of wearable item the user is reviewing. For example, as shown in FIG. 9, as the user is reviewing footwear, the set of related words 910 may include words such as narrow, comfort, shorter, heel, wider, toebox, cushion, larger, stability, arch support, length, and other words related to and typically used to describe the fit and performance of footwear.

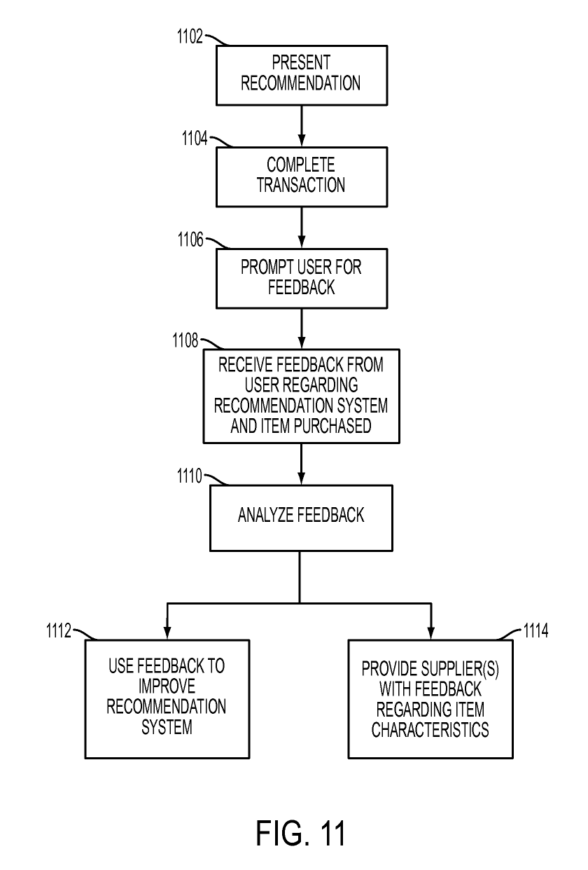

The feedback interface 900 may further provide the user with the option to save the review to their profile, at which time a copy of the review information can also be saved for further review and analysis. Such a process is described below in greater detail in regard to FIG. 11.

The system may make the feedback provided by a user available to other users accessing the size recommendation system. For example, FIG. 10 provides a sample screenshot of a user interface element illustrating a feedback review interface 1000. When a user accesses the feedback review interface 1000, the system may display a visual representation of how other users think the wearable item fits and performs. As shown in FIG. 10, the feedback review interface 1000 may include a graphic virtual model rendered as a visual representation 1002 of a wearable item, for example, a footwear item that the user accessing the recommendation system has selected and is considering buying. The system may prompt a user to select a portion of the visual representation and, in response to the selection, present feedback information collected from other users that is directly related to that portion of the item. For example, as shown in FIG. 10, the user can select a portion of the visual representation 1002 related to the length of the item and receive feedback from other users that is related to the length of the item. For example, as shown in FIG. 10, the visual representation 1002 indicates that 85% of reviewers agree with the recommendation that the item's length is a bit long.

The system map provide additional feedback information 1004 as well, indicating users' feedback related to additional fit or performance aspects of the item being viewed. For example, as shown in FIG. 9, additional feedback information 1004 related to length, toebox width and heel width may be provided. However, it should be noted that these characteristics are shown by way of example only, and additional characteristics may be shown, or alternative characteristics may be shown depending upon what type of item is being viewed.

Similarly, the feedback review interface 1000 may include a collection 1006 of the text reviews as left by previous reviewers, as well as an indication of whether the previous reviewer agreed with the recommendation system or not. A user viewing the feedback review interface may have the option to select an individual review from the collection to see additional information related to that review.

Alternatively, the system may make the aggregated review information accessible to consumers via user interfaces and/or websites beyond the feedback review interface 1000 as shown in FIG. 10. For example, a retailer's website may include the aggregated review information for quick access by a consumer. Similarly, a manufacturer may include the aggregated review information on its product website, providing an interested customer additional feedback related to an item that they may be interested in purchasing.

Beyond merely providing the feedback information to other users, the recommendation system can further process and analyze the information to make improved recommendations. Additionally, the system can use the feedback information to identify trends related to a specific manufacturer, and it may provide that information to the manufacturer. For example, a manufacturer can purchase a subscription from the company managing the recommendation system to receive aggregated and analyzed feedback information at regular intervals, or when a trend is identified regarding one of the manufacturer's products.

FIG. 11 depicts a sample process for collecting, aggregating and analyzing the feedback information, according to an embodiment. As before, the recommendation system may present 1102 a recommendation to a user. For example, the recommendation system may receive an inquiry for a user-selected wearable item and generate a recommended size for the wearable item for the user. More specifically, the recommendation system may access a database including a plurality of representative model of wearable items. The recommendation system may also access a user's profile to determine a size of a wearable item the user has indicated they have previously owned or worn. Based upon a comparison of the profile data and the representative models of the user-selected item, the recommendation system can generate and present 1102 the size recommendation to the user. The user can then opt to purchase the recommended item, and the recommendation system (or a purchasing computer or system associated with the recommendation system) can complete 1104 the transaction and update the user's profile to indicate that the user has purchased the item.

After the user has purchased the item, the recommendation system may generate and/or send a message to the user to prompt 1106 the user to provide feedback regarding the recommended size for the purchase item. For example, an email or other similar electronic message may be send to the user after a period of time has elapsed from the purchase date. Alternatively or additionally, the user may be prompted 1106 to provide feedback information the next time that they access the recommendation system. The feedback may be an assessment of the fit and/or performance of the item as described above.

Once a user has provided the feedback, the recommendation system, or an information analysis system associated with the recommendation system, may receive 1108 the feedback information and analyze 1110 the feedback. Analysis of the feedback information may include analyzing the individual user's feedback for any anomalies or information that would indicate an error by either the user or the recommendation system. Similarly, the feedback information may be analyzed to determine that the user received the correct product. For example, if the user indicates that the overall length of the item they received is off by more than an acceptable amount, it may be determined that the user has received an improperly marked or manufactured item.

Additionally, the user feedback can be combined with additional user feedback related to the same item to provide a group analysis of both the recommendation system's output for that item (e.g., how accurate is the recommended size being output for that item) as well as to determine any trends related to the manufacturer of that item (e.g., nearly 30% of all users report that the item runs much smaller than the size would indicate). Such a group analysis 1110 can provide a larger scale view of both the recommendation system's recommendation as well as the manufacturing characteristics of the item.

Based upon the analysis, the recommendation system can use 1112 the feedback information to improve the recommendation system. For example, if users are consistently indicating that a sizing recommendation for a particular shoe is wrong, and that the actual size of the shoe is smaller than recommended, the recommendation system may recognize that a high number of users are leaving negative feedback, and provide a report or an indication to an administrator or other similar personnel that the stored measurements for that particular item may need to be reviewed. Thus, the system may use the feedback to determine whether or not a particular footwear model runs true to size.

The recommendation system can also use the feedback information to identify products that receive at least a threshold amount of positive feedback or negative feedback, as well as trends among products. For example, the recommendation system may identify a product where a high percentage (e.g., over 90%) of purchasers are providing positive reviews. The recommendation system may then be more likely to provide that item as a recommended item for purchase based upon the historically positive feedback.

Additionally, user feedback can be used to evaluate new recommendation algorithms, and determine which, if any, aspects of the new recommendation should be maintained or eliminated. For example, the recommendation system may adjust the recommendation algorithm to place a higher or lower weight on certain fit aspects than others when generating a recommendation. However, if the feedback related to recommendations using the new algorithm are generally negative, the recommendation system may automatically tweak or otherwise alter the new algorithm to change which fit aspects are more highly weighted. Similarly, a system administrator or other software programmer working with the recommendation system may tweak or otherwise alter the new algorithm. Conversely, if the feedback related to recommendations using the new algorithm are generally positive, aspects from the new algorithm may be incorporated into existing algorithms as well.

Similarly, the recommendation system can be used to provide 1114 suppliers or manufacturers of the items being reviewed with the feedback information. The recommendation system may monitor the feedback information to identify one or more trends in the information such as a collection of reviewers having the same or similar negative feedback regarding an item. If the number of reviewers exceeds a particular threshold as set by the manufacturer (e.g., 25%), the recommendation system may be configured to provide 1114 the manufacturer with a notice indicating the negative feedback.

Conversely, the recommendation system can also provide 1114 positive feedback to the manufacturer as well. For example, a manufacturer may include a new feature on an item for sale. The recommendation system may collect and analyze positive feedback related to the item and, more specifically, to the new feature. If a particular trend is determined, or if the number of positive reviewers exceeds a particular threshold as set by the manufacturer (e.g., 90%), the recommendation system may provide 1114 the positive feedback to the manufacturer.

In addition to merely providing an indication of feedback, the notices to the manufacturer may include a recommendation that the manufacturer alter one or more physical components of the item, adjust an internal or external dimension of the item, change a material used in the manufacture of an item, or manufacture a new item that combines several liked features (or eliminated several disliked features) from one or more reviewed items.

Additionally, feedback received from a particular user can be used to develop a customized product specifically for that user. The system may provide a user's individual feedback to a manufacturer, and the manufacturer may contact the user to inquire about create a customized product specifically for that user. For example, a user may indicate that nearly all fit aspects of a particular shoe are highly rated, but that the overall width of the toe box is too tight. The manufacturer of the shoe may receive the feedback, and contact the user with alternative footwear that may better suit their sizing requirements, or with the option to create a customized product. For example, professional athletes or other similar consumers with a high demand for proper fit, may use the recommendation system and feedback collection mechanism as described herein to work with a manufacturer to produce a properly fitting article of clothing.

It should be noted that the processes and related examples as discussed with respect to FIG. 11 and the screenshots and user interfaces illustrated in FIGS. 9 and 10 are directed to footwear by way of example only. The processes and techniques as described in the present disclosure can be applied to all wearable items, beyond those specific examples included herein.

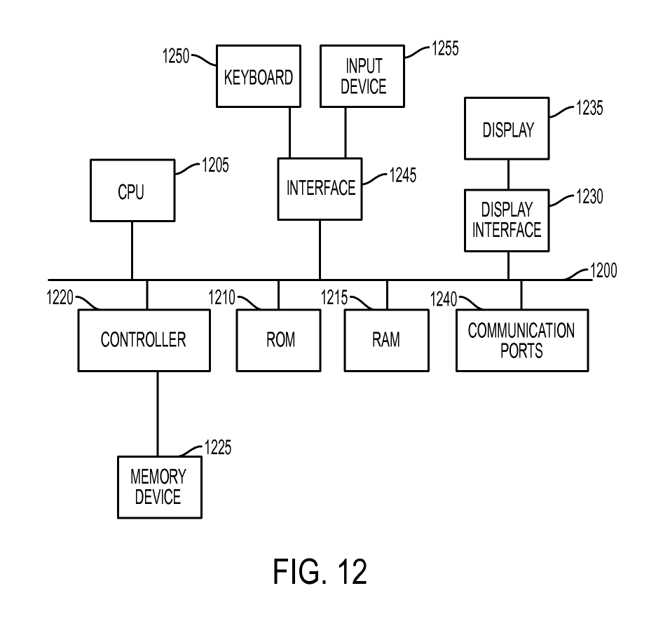

FIG. 12 depicts an example of internal hardware that may be used to contain or implement the various computer processes and systems as discussed above. An electrical bus 1200 serves as an information highway interconnecting the other illustrated components of the hardware. A computing device will include one or more processors. CPU 1205 is a central processing unit of the system, performing calculations and logic operations required to execute a program. CPU 1205, alone or in conjunction with one or more of the other elements disclosed in FIG. 12, is a processing device, computing device or processor as such terms are used within this disclosure. Read only memory (ROM) 1210 and random access memory (RAM) 1215 constitute examples of memory devices. As noted above, the terms “processor” and “memory” may include single devices, as well as a collection of devices that collectively perform a process (in the case of processors) or that collectively store a set of data or instructions (in the case of memory devices).

A controller 1220 interfaces with one or more optional memory devices 1225 that service as data storage facilities to the system bus 1200. These memory devices 1225 may include, for example, an external DVD drive or CD ROM drive, a hard drive, flash memory, a USB drive, a distributed storage medium such as a cloud-based architecture, or another type of device that serves as a data storage facility. As indicated previously, these various drives and controllers are optional devices. Additionally, the memory devices 1225 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 1210 and/or the RAM 1215. Optionally, the program instructions may be stored on a tangible computer readable medium such as a compact disk, a digital disk, flash memory, a memory card, a USB drive, an optical disc storage medium, a distributed storage medium such as a cloud-based architecture, and/or other recording medium.

A display interface 1230 may permit information from the bus 1200 to be displayed on the display 1235 in audio, visual, graphic or alphanumeric format. Communication with external devices may occur using various communication ports 1240. A communication port 1240 may be attached to a communications network, such as the Internet, a local area network or a cellular telephone data network.

The hardware may also include an interface 1245 which allows for receipt of data from input devices such as a keyboard 1250 or other input device 1255 such as a remote control, a pointing device, a video input device and/or an audio input device.

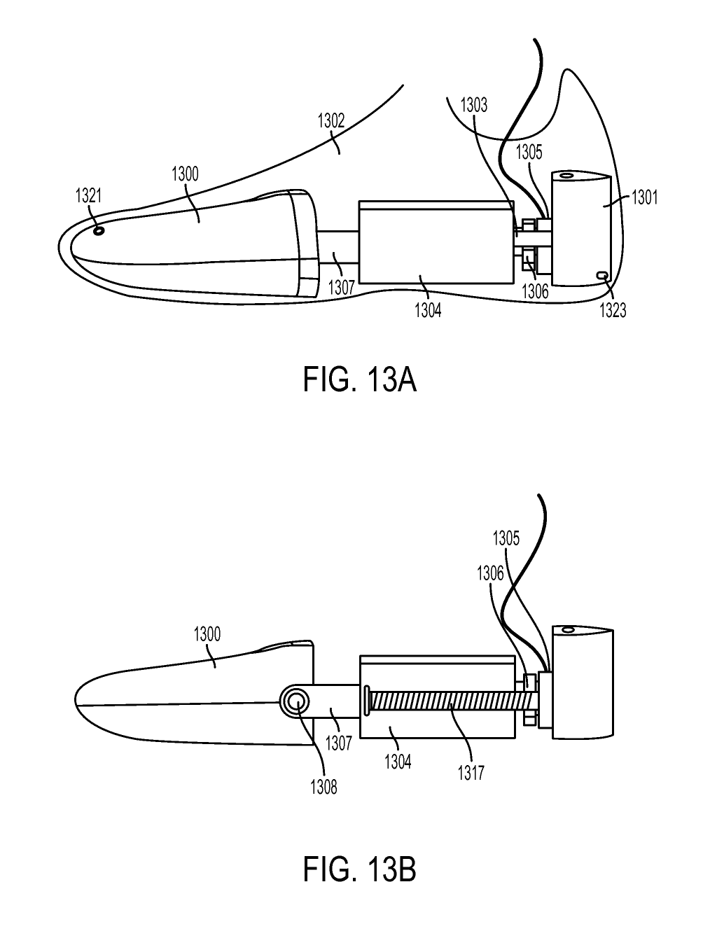

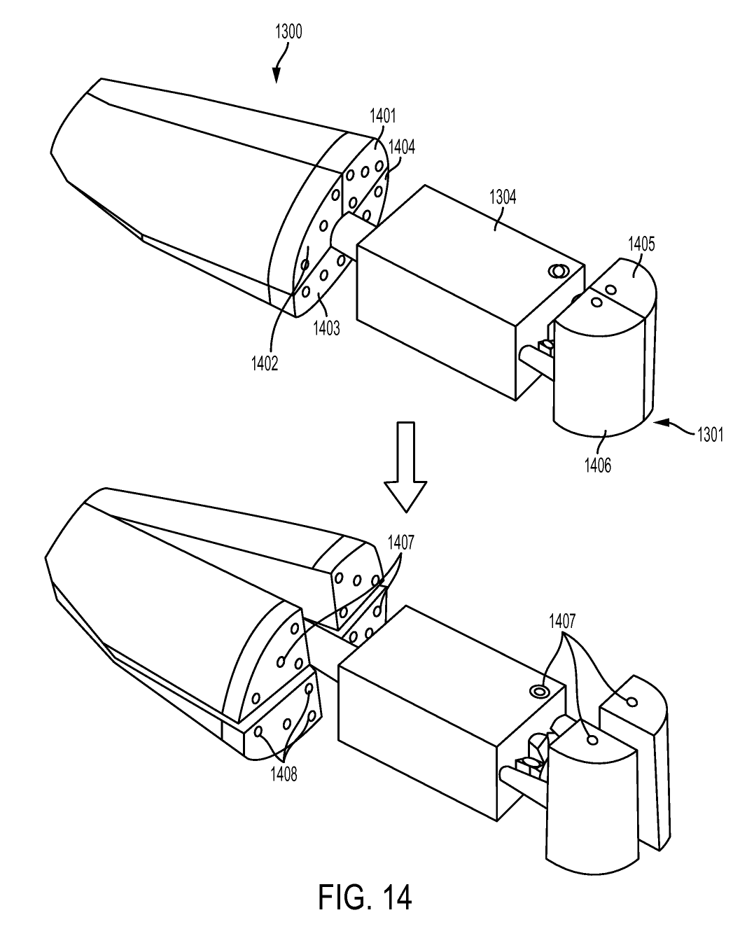

FIGS. 13A and 13B illustrate an example of a scanning device that is adjustable and which may be inserted into a footwear item 1302 to measure the item's internal measurements and determine the parameters for a reference footwear item model. FIG. 13A shows the device inside a shoe, while 13B illustrates a cross section of the device. In this example, the internal measurement device includes a front or toe portion 1300 connected via one or more elements to a rear or heel portion 1301. The device further includes a guide bar 1303 connecting the heel portion 1301 to a base 1304, a connector 1307 connecting the toe portion 1300 to the base 1304, a force gauge 1305 configured to provide tactile feedback on stretch and material deformation when the adjustable fixture is expanded, and a rotating knob 1306 positioned about the guide bar 1303 and configured to cause the adjustable fixture to expand or retract when rotated. In the embodiment illustrated in FIGS. 13A-13B, the device has the form of a shoe tree, although other adjustable structures may be used for the device. Adjustable fixtures may be configured to fit within other objects of interest, such as garments, other footwear or other wearable items. For example, a mannequin structure may be used for determining the internal dimensions of various apparel items such as a shirt, pants or a dress. The device also includes a drive shaft 1317 housed inside base 1304 and connected to rotating knob 1306. The drive shaft 1317 expands or retracts the device when the rotating knob is turned to meet the required length of the particular shoe. The connector 1307 may be a spring or manually be adjusted to a specific length and may include a joint 1308 allowing flexibility of the toe portion 1300. The device also includes one or more sensors 1321, 1323, such as pressure sensors that can detect when the device encounters resistance (and how much resistance) such as that which may occur when the sensor contacts an interior wall of the shoe. The measurements collected by the device may be transmitted to the system for storage in its data set as the set of reference parameters for reference model of a particular size of the footwear item, either directly via a wired or wireless connection, or indirectly via one or more data storage devices. Reference models may be collected in this manner and stored for multiple sizes of a particular footwear item model.

The toe portion 1300 of the device may be divided into multiple sections. For example, FIG. 14 illustrates that the toe portion 1300 may include four sections 1401, 1402, 1403, and 1404 that are configured to enable the toe portion 1300 to expand in width, height, and girth. The heel portion 1301 also may also be divided into multiple sections. For purposes of illustration, the heel portion 1301 shown in FIG. 14 includes two sections 1405 and 1406 configured to expand to a width of the heel when inserted into a footwear item. It should be noted the device may have more or fewer sections at the toe portion 1300 and heel portion 1301.

Optionally, each of sections 1401, 1402, 1403, 1404, 1405 and 1406 may have a fiducial marker or other type of reference point 1407 attached or otherwise integrated therein. These reference points 1407 may also be located on another connected portion such as a base 1304. The location of each of the reference points 1407 may be determined before and after expanding the adjustable fixture to determine the amount of expansion of the adjustable fixture. There may be additional secondary orientation points 1408 on each section as well to determine the angular position of each section. Alternatively, the system may measure expansion of the fixture simply by measuring linear displacement of various sections, for example how far toe portion 1300 moves away from heel portion 1301, how far the heel portion sections 1405, 1406 move away from each other, how far any toe portion pair (e.g., 1401/1402 or 1401/1404) moves apart, etc.

Data related to the position of each of the reference points 1407 and the secondary orientation points 1408 may be collected both when the device is in a retracted state as well as when the adjustable fixture is in its expanded state. As the positions of the reference point 1407 and secondary orientation points 1408 are known prior to expanding the device, by measuring the change in position of the points, a three-dimensional (3D) modeling or similar imaging system may determine a 3D model of the internal dimensions of the shoe. Alternatively, other methods of determining expansion may be used, such as a measure of a number of turns of a drive shaft that causes one portion of the device to move away from another portion of the device. A 3D model may be a digital image or representation of the internal dimensions of an object or an object being measured, in this example a shoe or the device used to measure the shoe. The 3D model may include data relating to width, height, depth, circumference, girth, and other related measurements at numerous locations about the item being measured.

For example, the system may start with a 3D model of the measuring device in a retracted position, and create a 3D model of the interior of the shoe based on the 3D data taken from the device when it is expanded in the shoe. For example, if a shoe is being measured, various internal dimensions such as toe-box width, toe-box height, girth, internal length and other related dimensions may be accurately determined by the position of the expanded shoe tree and used to create a 3D model of the shoe. Returning to FIG. 13, a force or pressure gauge 1305 may be configured to provide feedback such that an operator of the adjustable fixture can make sure the amount of expansion of the adjustable fixture is consistent between footwear. A particular force may be applied to the adjustable fixture in order to capture the deformation and stretch of the shoe under similar weight bearing loads that a shoe experiences when being put on an individual's foot. A calculation to determine an amount of stretch and deformation for a shoe may be performed based upon the amount of expansion of the shoe fixture under a given force or forces. For example, each shoe measured may be subjected to a range of forces from 10 pounds per square inch (psi) to 100 psi. At each 10 psi increment (i.e., 10 psi, 20 psi, 30 psi, . . . ), the amount of stretch and deformation may be measured and recorded in the database along with the internal measurements of the shoe. Force feedback also may be collected from one or more pressure sensors located at the surface of the toe and/or heel portion

Expansion of the adjustable fixture, and the resulting application of force, may be performed manually through a mechanical mechanism used to increase the force applied (e.g., through a ratcheting device, a screw device configured to increase the adjustable fixture in length and width thereby applying additional force, or another force application device device). Alternatively, the expansion may be performed automatically via a robotic process (e.g., a small electric motor configured to drive an expanding worm or screw drive configured to increase the adjustable fixture in length and width) or via a hydraulic process (e.g., a pressurized liquid or gas may be pumped into the adjustable fixture, thereby causing expansion of the adjustable fixture).

Various related values may be determined based upon the amount of stretch and deformation as well. For example, a support value may be determined based upon the amount of stretch. A shoe with a low value of stretch may be more likely to provide a high level of support. Similarly, a comfort level may be determined and stored based upon the amount of stretch and deformation. A shoe having a high level of stretch and deformation may result in a low comfort rating as the shoe may be likely to rub the wearer's foot in various areas due to the stretch and deformation.

The features and functions discussed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method of generating a user-specific recommended size of a wearable item, the method comprising:
by one or more processors:
accessing a memory device containing a data set containing parameters for a plurality of wearable items,
identifying a wearable item from the data set, querying the memory device to retrieve the parameters for the identified wearable item, and analyzing the retrieved parameters to determine whether the identified wearable item runs true to size, and
saving the determination of whether the selected product runs true to size to the data set; and
by one or more of the processors:
receiving, from a first user via a user interface, a selection of the identified wearable item,
querying the memory device to receive the determination of whether the selected product runs true to size,
in response to receiving a determination that the selected product does not run true to size, determining an alternate size of the wearable item that is appropriate for the user,
generating a recommendation that the user select the alternate size for the product, and
causing an output of an electronic device to present the recommendation to the user.

2. The method of claim 1, wherein:
the data set also contains parameter-specific feedback received from one or more consumers for at least some of the wearable items; and
determine whether the identified wearable item runs true to size also comprises analyzing the parameter-specific feedback.

3. The method of claim 1, further comprising by one or more of the processors:
presenting, to each of the one or more consumers, a user interface comprising a visual representation of the wearable item;
receiving, from each of the one or more consumers via the user interface, a selection of a portion of the wearable item;
in response to receiving each selection by one of the one or more consumers, presenting the consumer with a feedback interface by which the consumer may enter performance feedback or fit feedback related to the selected portion of the wearable item; and
saving the received feedback to the data set for the wearable item.

4. The method of claim 1, wherein:
determining the alternate size comprises:
accessing the data set to receive a model representation for the selected wearable item, wherein the model representation comprises one or more sizes and, for each size, a plurality of measured parameters of the wearable item in that size,
accessing profile data for the user, and
using the profile data for the user and the model representation for the selected item to determine the alternate size.

5. The method of claim 1, wherein determining the alternate size comprises:
prompting the user to input alternate sizing information, wherein the alternate sizing information comprises an indication of whether the user may purchase a size that is larger or smaller than a primary size for the user; and
using the alternate sizing information to determine the alternate size.

6. The method of claim 1, wherein determining the alternate size comprises:
accessing the data set to receive a model representation for the selected wearable item, wherein the model representation comprises one or more sizes and, for each size, a plurality of measured parameters of the selected wearable item in the user's primary size;
determining whether one or more of the parameters of the selected wearable item differ from one or more reference parameter values by at least a threshold amount;
if the measured parameters of the selected wearable item are greater than one or more of the reference parameters by at least the threshold amount, then selecting the alternate size as a size that is smaller than the primary size;
if the measured parameters of the selected wearable item are less than one or more of the reference parameters by at least a threshold amount, then selecting the alternate size as a size that is larger than the primary size; and
if the measured parameters of the selected wearable item are neither less than nor greater than one or more of the reference parameters by at least a threshold amount, then selecting the primary size as the alternate size.

7. The method of claim 1, further comprising, by one or more of the processors:
after the user has purchased the selected wearable item in the alternate size, presenting the user with a prompt to provide feedback relating to a quality of the recommendation;
receiving the feedback from the user in response to the prompt; and
saving the feedback to the memory device containing the data set for the selected wearable item.

8. The method of claim 7, wherein:
presenting the user with the prompt to provide feedback relating to a quality of the automated recommendation comprises presenting the user with a graphic virtual model of the selected wearable item, along with a description of the measured characteristic of the wearable item and a visual indication of a location on the wearable item that is associated with the measured characteristic; and
receiving the feedback from the user comprises receiving an indication of whether the user considers the description of the measured characteristic to be accurate.

9. The method of claim 1, wherein presenting the user with the recommendation of the recommended size comprises:
receiving, via a user interface that presents a visual indication of the selected item, a user selection of a location on the selected item; and
in response to receiving the indication of the user selection of the location, causing the user interface to display a measured parameter of the selected wearable item that is associated with the selected location.

10. The method of claim 1, further comprising, by one or more processors:
receiving feedback from a plurality of additional consumers, wherein the received feedback from the additional consumers is in response to additional recommendations for the selected item in the selected size that were presented to the additional consumers;
analyzing the feedback to identify a trend in a physical characteristic of the selected wearable item for which the additional users substantially consistently express negative feedback; and
sending a supplier of the selected wearable item a message comprising a summary of the negative feedback and the characteristic of the selected wearable item for which the additional users substantially consistently express negative feedback.

11. The method of claim 1, further comprising:
by a scanning device that is inserted into the identified wearable item, collecting a plurality of internal dimensional and tactile measurements of a plurality of parameters of the identified wearable item;
transmitting the collected dimensional and tactile measurements to the memory device;
saving the collected measurements in the data set as values of parameters for the identified wearable item; and
using the dimensional measurements as adjusted by the tactile measurements to determine the alternate size.

12. The method of claim 1, wherein determining whether the identified wearable item runs true to size is performed after the system receives the selection of the identified wearable item from the user.

13. A system for generating a user-specific size recommendation for a wearable item, the system comprising:
one or more processors;
a first memory device portion that stores a data set containing parameters for a plurality of wearable items;
a second memory device portion containing programming instructions that are configured to cause one or more of the processors to:
identify a wearable item,
querying the memory device to retrieve the parameters for the identified wearable item, and
analyze the retrieved parameters to determine whether the identified wearable item runs true to size; and
a third memory device portion containing programming instructions that are configured to cause one or more of the processors to:
receive, from a first user via a user interface, a selection of the identified wearable item,
query the memory device to receive an indication of whether the selected product runs true to size,
in response to receiving an indication that the selected product does not run true to size, determining an alternate size of the wearable item that is appropriate for the user
generating a recommendation that the user select the alternate size for the product, and
causing an output of an electronic device to present the recommendation to the user.

14. The system of claim 13, wherein:
the data set also contains parameter-specific feedback received from one or more consumers for at least some of the wearable items; and
the instructions to determine whether the identified wearable item runs true to size also comprise instructions to analyze the parameter-specific feedback.

15. The system of claim 13, further comprising additional programming instructions that are configured to cause one or more of the processors to:
present, to each of the one or more consumers, a user interface comprising a visual representation of the wearable item;
receive, from each of the one or more consumers via the user interface, a selection of a portion of the wearable item;
in response to receiving each selection by one of the one or more consumers, present the consumer with a feedback interface by which the consumer may enter performance feedback or fit feedback related to the selected portion of the wearable item; and
save the received feedback to the data set for the wearable item.

16. The system of claim 13, wherein:
the instructions to determine the alternate size comprise instructions to:
access the data set to receive a model representation for the selected wearable item, wherein the model representation comprises one or more sizes and, for each size, a plurality of measured parameters of the wearable item in that size,
access profile data for the user, and
use the profile data for the user and the model representation for the selected item to determine the alternate size.

17. The system of claim 13, wherein the instructions to determine the alternate size comprise instructions to:
prompt the user to input alternate sizing information, wherein the alternate sizing information comprises an indication of whether the user may purchase a size that is larger or smaller than a primary size for the user; and
use the alternate sizing information to determine the alternate size.

18. The system of claim 13, wherein the instructions to determine the alternate size comprise instructions to:
access the data set to receive a model representation for the selected wearable item, wherein the model representation comprises one or more sizes and, for each size, a plurality of measured parameters of the selected wearable item in the user's primary size;
determine whether one or more of the parameters of the selected wearable item differ from one or more reference parameter values by at least a threshold amount;
if the measured parameters of the selected wearable item are greater than one or more of the reference parameters by at least the threshold amount, then select the alternate size as a size that is smaller than the primary size;
if the measured parameters of the selected wearable item are less than one or more of the reference parameters by at least a threshold amount, then select the alternate size as a size that is larger than the primary size; and
if the measured parameters of the selected wearable item are neither less than nor greater than one or more of the reference parameters by at least a threshold amount, then select the primary size as the alternate size.

19. The system of claim 13, further comprising additional programming instructions that are configured to cause one or more of the processors to:
after the user has purchased the selected wearable item in the alternate size, present the user with a prompt to provide feedback relating to a quality of the recommendation;
receive the feedback from the user in response to the prompt; and
save the feedback to the data set for the selected wearable item.

20. The system of claim 19, wherein:
the instructions to present the user with the prompt to provide feedback relating to a quality of the automated recommendation comprise instructions to present the user with a graphic virtual model of the selected wearable item, along with a description of the measured characteristic of the wearable item and a visual indication of a location on the wearable item that is associated with the measured characteristic; and
the instructions to receive the feedback from the user comprise instructions to receive an indication of whether the user considers the description of the measured characteristic to be accurate.

21. The system of claim 13, wherein the instructions to present the user with the recommendation of the recommended size comprise instructions to:
receive, via a user interface that presents a visual indication of the selected item, a user selection of a location on the selected item; and
in response to receiving the indication of the user selection of the location, cause the user interface to display a measured parameter of the selected wearable item that is associated with the selected location.

22. The system of claim 13, further comprising additional programming instructions that are configured to cause one or more of the processors to:
receive feedback from a plurality of additional consumers, wherein the received feedback from the additional consumers is in response to additional recommendations for the selected item in the selected size that were presented to the additional consumers;
analyze the feedback to identify a trend in a physical characteristic of the selected wearable item for which the additional users substantially consistently express negative feedback; and
send a supplier of the selected wearable item a message comprising a summary of the negative feedback and the characteristic of the selected wearable item for which the additional users substantially consistently express negative feedback.

23. The system of claim 13, further comprising a scanning device configured to be inserted into the identified wearable item and collect a plurality of internal dimensional and tactile measurements to be used as values of the parameters of the identified wearable item.
